(19) United States
(12) Patent Application Publication
(10) Pub. No.: US 2009/0158905 A1
(43) Pub. Date: Jun. 25, 2009

(54) Swiftly collapsible check plate unit for a table saw

(76) Inventor: Bor-Yann Chuang, Taichung County (TW)

Correspondence Address: BACON & THOMAS, PLLC, 625 SLATERS LANE, FOURTH FLOOR, ALEXANDRIA, VA, 22314-1176, US

(21) Appl. No.: 12/003,237

(22) Filed: Dec. 21, 2007

(51) Int. Cl. B23D 33/02; B23Q 3/00

(52) U.S. Cl. 83/471; 269/289 R

(57) ABSTRACT

A swiftly collapsible check plate unit for a table saw includes a separating plate, a combining base, a fixing member and two check plates. The two check plates are respectively positioned at two sides of the separating plate that has an engage groove with a collar opening. The fixing member has an engage block to correspond to the engage groove, and the engage block has two cut surfaces facing to an inner wall of the collar opening, so when a handling portion formed in a rear portion of the fixing member is turned, the engage block is tightly fixed in the engage groove, fixing tightly the combining base with the separating plate, with the two check plates also swiftly combined with the separating plate and the combining base, or collapsed swiftly as well by turning the handling portion in another way.

### BACKGROUND OF THE INVENTION

1. Field of the Invention

This invention relates to a check plate unit for a table saw, particularly to one swiftly combinable and collapsible.

2. Description of the Prior Art

A conventional check plate unit for a table saw shown in FIGS. 1 and 2 includes a separating plate 1, a combining base 2 and two check plates 3. The separating plate 1 has a round hole at one side near an upper end, and the combining base 2 has an insert slot 5 in a side to extend to a bottom so that the combining base 2 can be combined with an upper end of the separating plate 1. Further, a positioning shaft 6 is inserted in the round hole 4 of the separating plate 1, and a press button 7 is inserted in the round hole 4 from the other side of the positioning shaft 6 so the positioning shaft 5 can be pushed by the press button 7 to shift out of the round hole 4. However, mutual shifting of the positioning shaft 6 and the press button 7 should be very accurate to correspond to the center of the end surface of the knife plate 1, otherwise the positioning shaft 6 cannot fit in or shift out of the round hole 4, very difficult to handle them.

### SUMMARY OF THE INVENTION

This invention has bee devised to offer a swiftly collapsible check plate unit for a table saw, featured by a separating plate, a combining base, a fixing member and two check plates combined together.

The separating plate is provided with a fixing hole that has a collar opening and a round bottom. The fixing member is provided with an engage block with a size as the fixing hole of the separating plate, and the engage block has two cut surfaces to face to the inner wall of the collar opening. The fixing member further has a handling portion formed in its rear portion. After the fixing member is combined with said combining base through the separating plate, the handling portion can be turned to rotate the fixing member so as to fix firmly the combining base with the separating plate swiftly so that the two check plates are also combined with the separating plate. Thus the two check plates can be swiftly combined with the combining base and the separating plate at the same time or collapsed by turning the handling portion of the fixing member.

### BRIEF DESCRIPTION OF DRAWINGS

This invention will be better understood by referring to the accompanying drawings, wherein:

FIG. 1 is an exploded perspective view of a conventional check plate unit for a table saw;

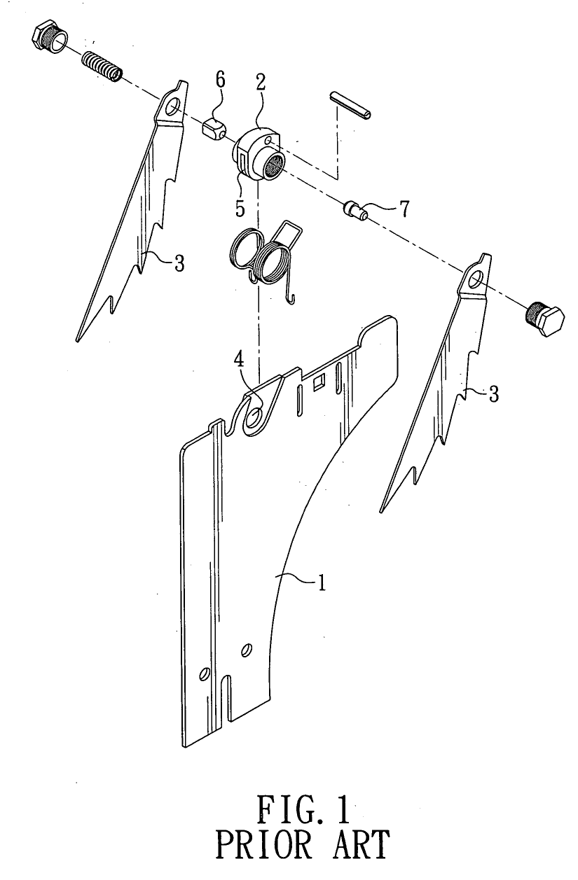

FIG. 2 is a cross-sectional view of the conventional check plate unit for a table saw;

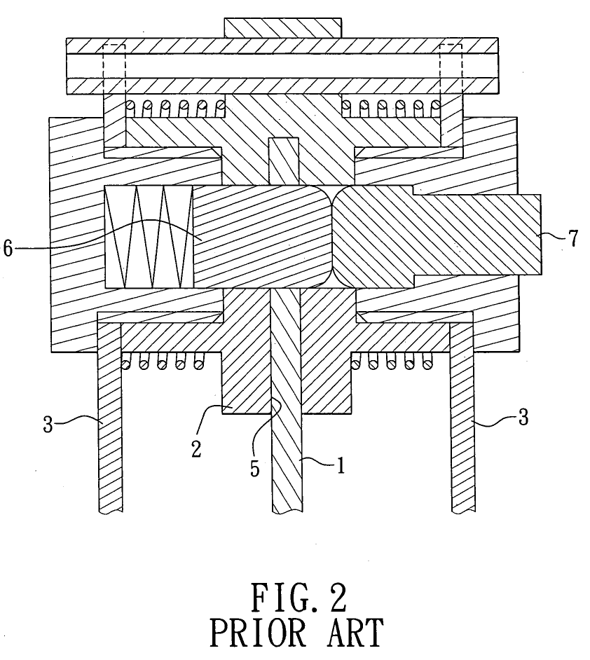

FIG. 3 is a perspective view of a check plate unit for a table saw in the present invention;

FIG. 4 is an exploded perspective view of the check plate unit for a table saw in the present invention;

FIG. 5 is a cross-sectional view of the check plate unit for a table saw in the present invention;

FIG. 6 is a side view of the check plate unit for a table saw in the present invention, showing it being used in one way;

FIG. 7 is a side view of the check plate unit for a table saw in the present invention, showing it being used in another way; and,

FIG. 8 is an exploded perspective view of a tightening member of a second preferred embodiment of a swiftly collapsible check plate unit for a table saw in the present invention.

### DETAILED DESCRIPTION OF THE PREFERRED EMBODIMENT

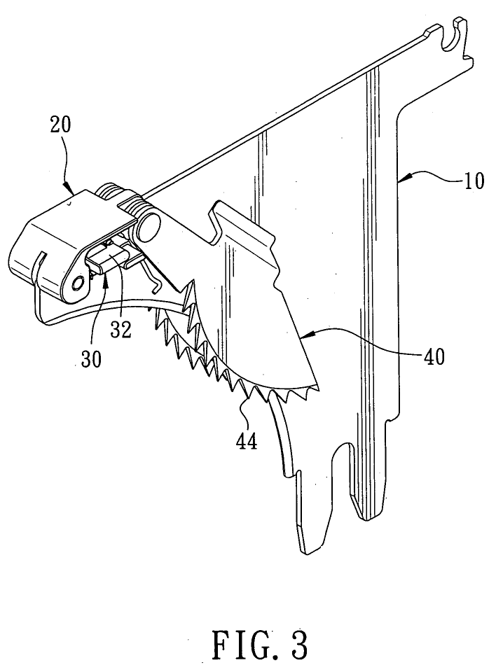

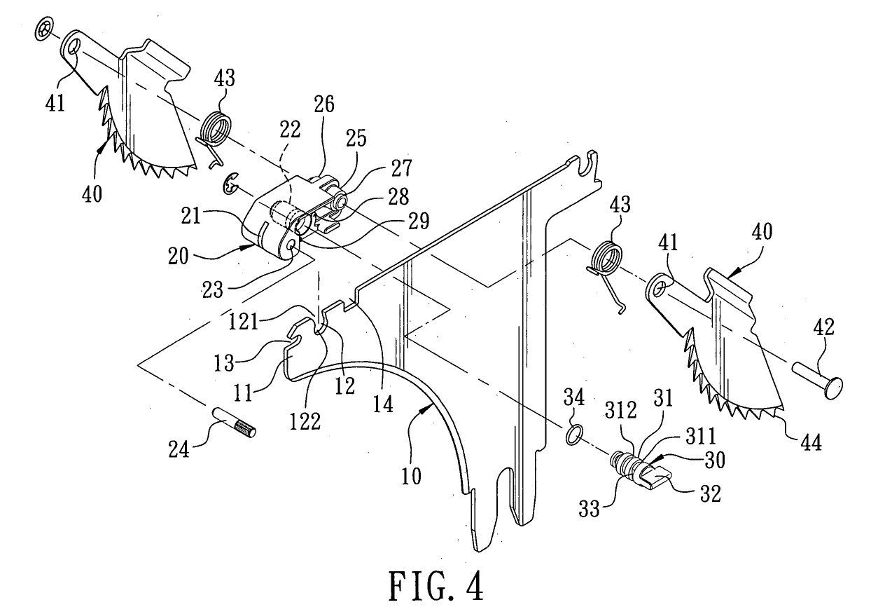

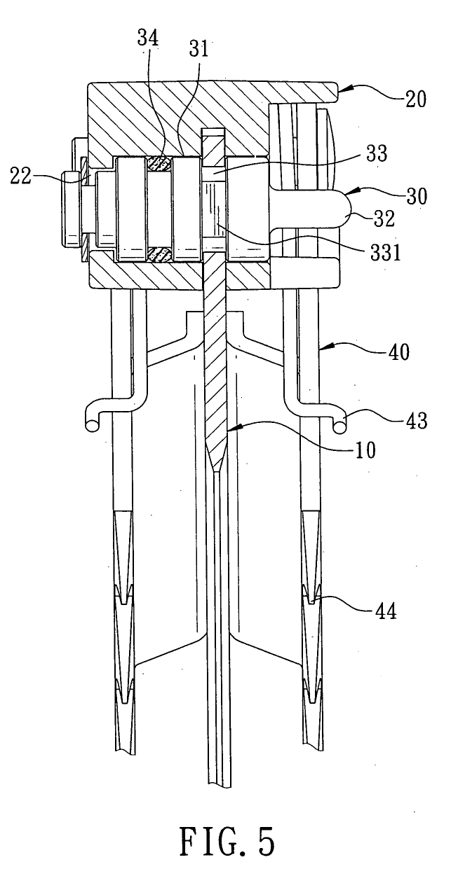

A preferred embodiment of a check plate unit for a table saw in the present invention, as, shown in FIGS. 3, 4 and 5, includes a separating plate 10, a combining base 20, a fixing member 30 and two check plates 40 as main components combined together.

The separating plate 10 is fixed on the body of a table saw (not shown), having a connect portion 11, an engage groove 12 formed in a side of an upper end and having a collar opening 121 and a round bottom 122, a pivot groove 13 of an oval shape formed in a left side, a rectangular recess 14 formed in an intermediate portion of the upper end. The rectangular recess 14 is positioned in parallel to the engage groove 12 and the pivot groove 13.

The combining base 20 is oval, having an insert slot 21 formed sidewise in a bottom to fit with the connect member 11 of the separating plate 10, a round-post shaped position hole 22 bored to correspond to the pivot groove 13 of the separating plate 10, a round-post shaped pivot hole 23 bored in a left side for a shaft 24 to extend therein and further in the pivot groove 13. Further, a shaft tube 25 and 26 is fixed in two sides of the rectangular recess 14 of the separating plate 10 for receiving a position tube 27 therein and further in the rectangular recess 14. Moreover, a first position limit member 28 and a second position limit member 29 are provided on a front annular surface of the position hole 22, located diagonally, with the first position limit member 28 located at the right side of the position hole 22 and with the second position limit member 29 located at the left side of the same hole 22. Both the first and the second position limit member 28 and 29 are of a post shape, and the first position limit member 28 is just at an upper end of the position hole 22, having a limit surface 281 formed in its bottom. The second position limit member 29 is just at a left lower end of the position hole 22, having a limit surface 291 at a side of the position hole 22.

The fixing member 30 is to fix the combining base 20 on the separating plate 10, having an engage portion 31, and a handle portion 32 formed to extend rearward from the engage portion 31 for rotating the fixing member 30. The engage portion 31 is shaped as a round post, just fitting in the position hole 22, and the handle portion 32 is located between the first and the second position limit member 28 and 29. The engage portion 31 is provided with a first annular groove 311 to correspond to the engage groove 12 with an engage block 33 formed in an inner wall of the first annular groove 311, and the engage block 33 has a same width as the round bottom 122 of the separating plate 10, and a cut surface 331 respectively at a left and a right side. Further, the engage portion 31 is provided with a second annular groove 312 in front of the second annular groove 311 for a tightening member 34 to be mounted around. The tightening member 34 is made of rubber of an O-shape. The handling portion 32 is perpendicular to the cut surfaces 331 of the engage block 33, possible to be shaped as rectangular or semicircular, and it is rectangular in this invention.

The two check plates 40 are respectively provided with a shaft hole 41 at an upper left end to correspond to the shaft tubes 25 and 26 of the combining base 20 for a shaft 42 to fit through and also in the shaft tubes 25 and 26 so the check plates 40 may be combined with the combining base 20. Further, a torque spring 43 is deposited between the shaft tubes 25 and 26 respectively and the shaft hole 41, so each check plate 40 may be pressed by each torque spring 43. In addition, each check plate 40 has plural teeth 44 formed along a lower curved edge.

Next, how to combine and use the check plate unit is to be described below.

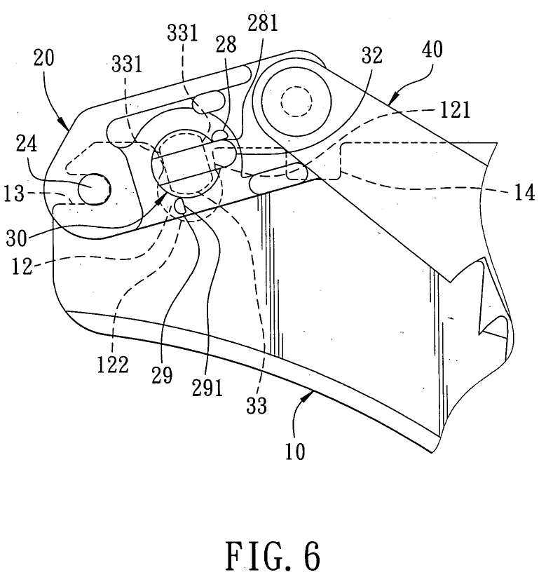

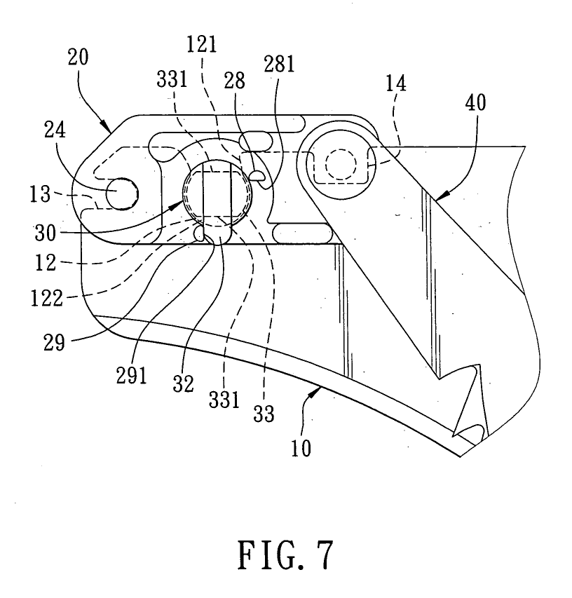

In assembling, at first, the pivot 24 is inserted in the pivot hole 23, and further in the pivot groove 13 of the separating plate 10. Then the fixing member 30 is inserted in the position hole 22 of the combining base 20, with the handling portion 32 in parallel to the limit surface 281 gripped to turn the engage portion 31 in the position hole 22 and with the right upper surface of the handling portion 32 restricted by the limit surface 281. Thus the proper position of the fixing member 30 may be exactly known for positioning. Next, the torque spring 43 and the check plate 40 are combined with the shaft tubes 25 and 26 respectively, and the shaft 42 is inserted through the whole 41 and the shaft tubes 25 and 26 to fix the torque springs 43 in place at two sides of the knife plate 10. Then the insert groove 21 of the combining base 20 is fitted with the connect portion 11 of the separating plate 10. Now referring to FIG. 6, the engage block 33 of the fixing member 30 can be placed in the collar opening 121 of the engage groove 12 with the two cut surfaces 331 contacting with the two side edges of the opening 121, also fitting in the round bottom 122. Next, as shown in FIG. 7, the handling portion 32 is turned toward the position limit member 29 at the left lower end of the position hole 22, and blocked by the limit surface 291 and prevented from excessive rotation, so that the handling portion 32 may be turned exactly to the cut surfaces 331, which can fit just in the round bottom 122, with the engage block 33 being wider than the collar opening 121 and forcing the engage block 33 restricted inside the engage groove 12. Moreover, the tightening member 34 at the front of the fixing member 30 more tightly stabilizes the engage block 31 in the position hole 22 without loosening off.

On the contrary, if the combining base 20 and the two check plates 40 are to be disassembled from the separating plate 10, the handling portion 32 is turned toward the limit member 28, to move the cut surfaces 331 back to the original position, so that the width of the engage block 33 can move out of the collar opening 121 to permit the fixing member 30 loosened out. Thus, the turning the handling portion 32 of the fixing member 30 can fix the combining base 20 with the separating plate 10 swiftly and conveniently.

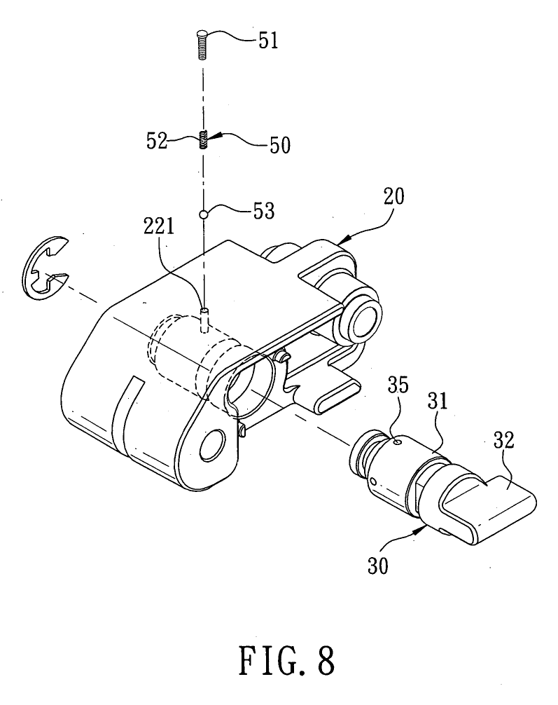

Next, FIG. 8 shows a second embodiment of a swiftly collapsible check plate unit for a table saw, having almost the same structure as the first preferred embodiment, except that a tightening member 50 replaces the tightening member 34 of the first embodiment, and a fixing member 30 has a little different shape from the fixing member of the first embodiment. The tightening member 50 is composed of a bolt 51, a compressing spring 52 fitting around the bolt 51 and a ball 53 placed at the lower end of the bolt 51. The fixing member 30 is provided with a plurality of recesses 35 spaced apart equidistantly around an annular surface of a front portion, and the combining base 20 is provided with a hole 221 to align with any of the recesses 35 in case of the fixing member 30 turned by the handling portion 32. When the fixing member 30 is set at one of plural positions by rotation, the bolt 51 is screed to engage with the hole 221 and the ball 53 can slide around the surface of the fixing member 30 and fits in one of the recesses 35 to keep tightly the fixing member 30 immovable at that position by screwing the bolt 51

The swiftly collapsible check plate unit for a table saw has the advantage that the two check plates 40 can swiftly be assembled with the separating plate 10 by means of the combining base 20, which is tightly assembled with the separating plate 10 by turning the handling portion 32 of the fixing member 30, and the combining base 20 is provided with the position limit members 28 and 29 for restricting the turning of the handle portion 32 to prevent excessive turning so that the handling portion 32 may accurately force the cut surfaces 331 of the engage block 33 fit in the engage groove 12, with the tightening member 34 keeping immovable the fixing block 33, finishing assembling the two check plates with the knife plate 10. On the contrary, if the two check plates 40 are to be collapsed, the handling portion 32 is turned to loosen the combining base 20 from the separating plate 10, and the two check plates 40 can automatically be loosened from the separating plate 10, quite swiftly and convenient to handle.

While the preferred embodiments of the invention have been described above, it will be recognized and understood that various modifications may be made therein and the appended claims are intended to cover all such modifications that may fall within the spirit and scope of the invention.

What is claimed is:

1. A swiftly collapsible check plate unit for a table saw, said check plate unit comprising:
a separating plate provided with an engage groove formed in an upper portion near a left end, said engage groove having an collar opening and a round bottom;
a combining base provided with an insert slot formed in a lower portion and extending to a left side for fitting with an upper end of said separating plate, said insert slot facing to said engage groove of said separating plate, said combining base further provided with a position hole formed axially and corresponding to said engage groove;
a fixing member inserted in said position hole of said combining base and provided with an engage portion and a handling portion extending rearward from said engage portion, said engage portion having a first annular groove corresponding to said engage groove of said separating plate, an engage block formed in an inner wall of said first annular groove, said engage block having opposite cut surfaces on a circumference corresponding to said collar opening, a tightening member placed at a front end of said fixing member and pressing against an inner wall of said position hole of said combining base; and,
Two check plates pivotally combined with two sides of said combining base respectively.

2. The swiftly collapsible check plate unit for a table saw as claimed in claim 1, wherein said engage block has a width just as that of said round bottom of said engage groove, and a width between said two cut surfaces of said engage block is just the same as that of said collar opening.

3. The swiftly collapsing check plate unit for a table saw as claimed in claim 1, wherein said engage member is shaped as a circular post to stably fit in said position hole of said combining base.

4. The swiftly collapsible check plate unit for a table saw as claimed in claim 1, wherein said separating plate is provided with a pivot groove, and said combining base is provided with a pivot hole corresponding to said pivot groove of said separating plate for a pivot to fit through and further in said pivot groove to function as a rotatable shaft.

5. The swiftly collapsible check plate unit for a table saw as claimed in claim 1, wherein said combining base is provided with two position limit members around a front side surface to face to said position hole, said two limits members are located diagonally around said front side surface, shaped as a semi-circular post, one of said position limit members is formed lateral and the other of said position limit members is formed longitudinal, and each said limit member is provided with a flat surface to push against a surface of said handling portion for restricting a turning angle of said handling portion.

6. The swiftly collapsible check plate unit for a table saw as claimed in claim 1, wherein said handling portion is formed in a rear portion of said engage member, shaped vertical to said cut surfaces of said engage portion of said engage member to be hand led to turn said engage member.

7. The swiftly collapsible check plate unit for a table saw as claimed in claim 6, wherein said handling portion is shaped as a rectangular block.

8. The swiftly collapsible check plate unit for a table saw as claimed in claim 6, wherein said handling portion is shaped as a semi-circular block.

9. The swiftly collapsible check plate unit for a table saw as claimed in claim 1, wherein said engage portion of said engage member is further provided with a second annular groove in front of said first annular groove, and a tightening member made of an O-shaped rubber ring is fitted around said second annular groove.

10. The swiftly collapsible check plate unit for a table saw as claimed in claim 1, wherein said tightening member consists of a bolt, a compress spring fitted around said bolt, and a ball positioned at a lower end of said bolt, said engage member is provided with plural recesses spaced apart equidistantly around an annular surface of a front portion, said combining base is provided with a hole facing any one of said recesses for said ball to engage therein to tighten said engage member in place when pressed by said bolt.
